(19) United States
(12) Patent Application Publication
(10) Pub. No.: US 2011/0181623 A1
(43) Pub. Date: Jul. 28, 2011

(54) SCROLLING CONTROL METHOD FOR A TOUCH DEVICE AND DEVICE USING THE SAME

(76) Inventors: Xiaoning LIU, Shenzhen (CN); Fan LIU, Shenzhen (CN); Bangjun HE, Shenzhen (CN); Yun YANG, Shenzhen (CN)

(21) Appl. No.: 12/910,290

(22) Filed: Oct. 22, 2010

(30) Foreign Application Priority Data
Jan. 28, 2010 (CN) 201010103747.1

(51) Int. Cl. G09G 5/00

(52) U.S. Cl. 345/676

(57) ABSTRACT

A scrolling control method for a touch device, comprising the steps of: selecting a scrolling region on the touch device; defining at least two sections on the scrolling region; detecting touches of an object on at least two different sections successively, the time span between the touches of the object on the two sections corresponding a displacement; and controlling a scroll bar to scroll the displacement according to the operation of the object on a window of the touch device.

### CROSS-REFERENCE TO RELATED APPLICATION

This application claims foreign priority benefits under 35 U.S.C. §119 of Chinese Patent Application Serial No. 201010103747.1, filed on Jan. 28, 2010, the content of which is incorporated herein by reference in its entirety.

### TECHNICAL FIELD

Exemplary embodiments of the present invention generally relate to a touch device, and in particular, relate to a scrolling method for a touch device and a device using the scrolling method.

### BACKGROUND

Graphical User Interface (GUI) is well known to most of the people. One of the main functions for a GUI is scrolling a window screen (including up-down scrolling and left-right scrolling) to provide easy browsing for a user. Therefore, a scroll bar is provided at an edge of the window (up-down edge or left-right edge) to allow the user to press on and drag along a parallel direction of the scroll bar with a mouse to scroll the window screen.

A touchpad has the advantages of simple, light and low price, so it is widely applied to various kinds of electronic devices to replace primary input devices, for example, to replace mouse for computers.

An input command such as writing and scrolling may be achieved by using a finger or a conductive object to touch the touch device or slide on the touch device to make the cursor to move. For the application of a scrolling bar, a general method is defining scrolling regions to control the scrolling of the scrolling bar. Referring to FIG. 1, the touchpad 10 comprises a cursor operation region 11, a vertical scrolling region 110, and a horizontal scrolling region 120. The vertical scrolling region 110 is divided into a plurality of sections 111, 112, 113 and 114, each of which corresponds to a displacement. The horizontal scrolling region 120 is divided into a plurality of sections 121, 122, 123, and 124, each of which corresponds to a displacement. When the user wants to move the cursor, he needs to land a finger on the operation region 11 and the cursor moves according to the movement of the finger. When the user wants to scrolling the window vertically, he needs to land a finger on a section of the vertical scrolling region 110 and the window is scrolled a preset displacement. Similarly, when the user wants to scroll the window horizontally, he needs to land a finger on a section of the horizontal scrolling region 120 and the window is scrolled a preset displacement.

In the prior art, each section corresponds to a preset displacement in a specific direction. If the user needs more displacements, the vertical scrolling region 110 and the horizontal scrolling region 120 have to be defined to have a plurality of sections. The more displacements the user needs, the more sections the vertical scrolling region 110 and the horizontal scrolling region 120 have to have. Because the area of the touchpad is limited, the number of the sections can be defined on the vertical scrolling region 110 and the horizontal scrolling region 120 is also limited. Users often need various displacements, which often cannot be satisfied with the limited area.

### BRIEF SUMMARY

The present disclosure provides a scrolling method for a touch device and a device using the scrolling method that may provide various displacements.

According to one exemplary embodiment of the invention, a scrolling control method for a touch device comprises the steps of: selecting a scrolling region on the touch device; defining at least two sections on the scrolling region; detecting touches of an object on at least two different sections successively, of which the time period between the touch of the object on the two sections corresponds to a displacement in a specific direction; and controlling a scroll bar to scroll the displacement in the specific direction according to the operation of the object on a window.

According to one exemplary embodiment of the invention, a scrolling control device comprising a touchpad comprising a scrolling region, wherein a time snap between a touch of an object on the two sections of the sections is corresponding to a displacement in a specific direction when at least two sections are touched successively.

According to the scrolling method for a touch device and device using the same, when at least two sections are touched successively, a time snap between a touch of an object on the two sections of the sections is corresponding to a displacement in a specific direction, so the user may obtain different displacements by determining different time spans for himself.

### BRIEF DESCRIPTION OF THE DRAWINGS

The foregoing summary, as well as the following detailed description of the invention, will be better understood when read in conjunction with the appended drawings. The embodiments illustrated in the figures of the accompanying drawings herein are by way of example and not by way of limitation. In the drawings:

FIG. 1 is a schematic diagram of scrolling control of the touch device in the prior art;

FIG. 2 is a flow chart of a scrolling control method for a touch device according to one embodiment of the present invention;

FIG. 3 is a flow chart of a scrolling control method for a touch device according to another embodiment of the present invention;

FIG. 4 is a schematic diagram of a scrolling operation on a touch device and the reaction of a window corresponding to the operation according to one embodiment of the present invention;

FIG. 5 is a schematic diagram of a scrolling operation on a touch device and the reaction of a window corresponding to the operation according to one embodiment of the present invention;

FIG. 6 is a schematic diagram of a scrolling operation on a touch device and the reaction of a window corresponding to the operation according to one embodiment of the present invention;

FIG. 7 is a schematic diagram of a scrolling operation on a touch device and the reaction of a window corresponding to the operation according to one embodiment of the present invention; and

FIG. 8 is a schematic diagram of a scrolling operation on a touch device and the reaction of a window corresponding to the operation according to one embodiment of the present invention.

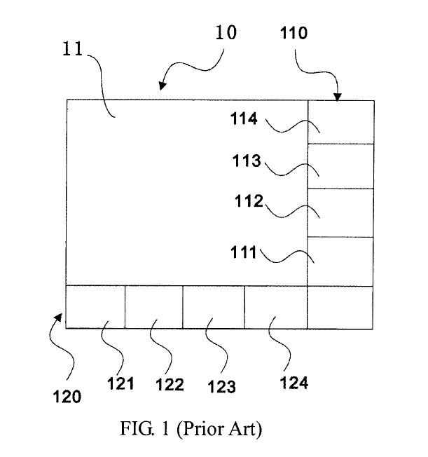

### DETAILED DESCRIPTION

The embodiments of the present invention now will be described in detail hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

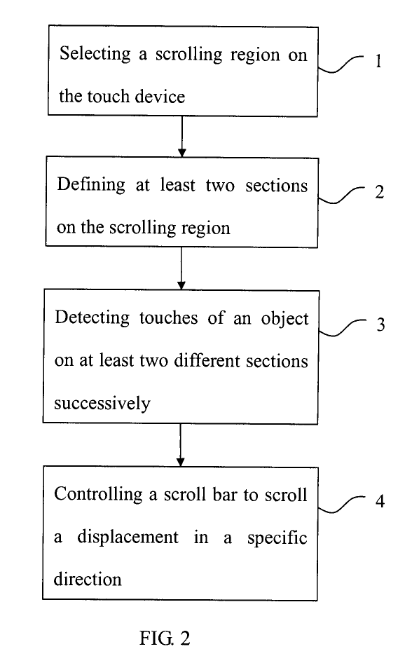

FIG. 2 shows a flow chart of a scrolling control method for a touch device in some embodiments of the present invention. The method comprises the steps of: in step 1, selecting a scrolling region on the touch device; in step 2 defining at least two sections on the scrolling region; then in step 3, detecting touches of an object on at least two different sections successively, the time period between the touches of the object on the two sections corresponding to a displacement, and the touches of the object on the sections successively representing a movement in a specific direction of the object on the touch device; controlling a scroll bar in a window displayed on a display device to scroll the displacement in the specific direction according to the operation of the object in step 4.

In some embodiments of the present invention, two or more than two sections are disposed in a horizontal direction. In some embodiments of the present invention, two or more than two sections are disposed in a vertical direction. In some embodiments of the present invention, two or more than two sections are disposed in the horizontal direction and two or more than two sections are disposed in the vertical direction.

In some embodiments of the present invention, the specific direction comprises a vertical direction. In some embodiments of the present invention, the specific direction comprises a horizontal direction. In some embodiments of the present invention, the specific direction comprises a vertical direction and a horizontal direction. In some embodiments of the present invention, the specific direction comprises a horizontal direction, vertical direction, upper right direction, bottom right direction, upper left direction, and bottom left direction.

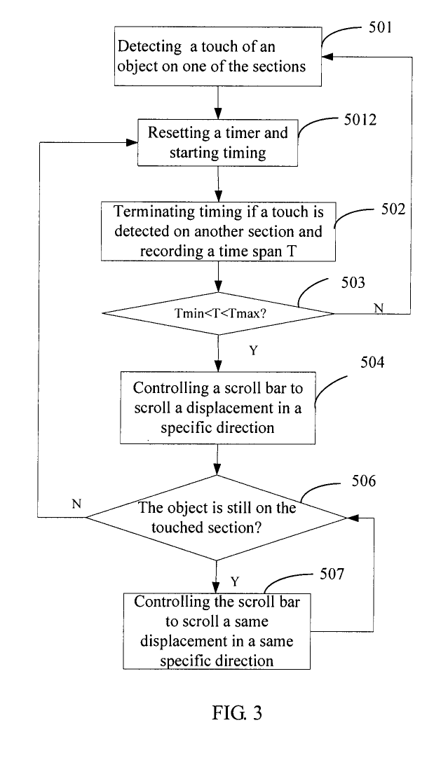

FIG. 3 illustrates another embodiment of the scrolling control method for a touch device. The method comprises the steps of: detecting a first touch of an object on one of the sections on the touch device in step 501; resetting a timer and starting timing in step 5012; terminating timing if a second touch of the object is detected on another section and recording a time span T between the two touches in step 502; comparing the time span T with a first reference time and a second reference time in step 503, and if the time span T is greater than a first reference time and less than a second reference time, controlling a scroll bar in a window displayed on a display device to scroll a displacement in a specific direction according to the operation of the object on the touch device in step 504, wherein the displacement is determined by the length of the time span T and the specific direction is determined by a location relationship between the touched sections, else jump to step 501; detecting whether the object is still on the touched section in step 506; if yes, controlling the scroll bar to scroll a same displacement in a same specific direction on the window in step 507; else, jumping to step 5012.

In some embodiments of the present invention, a scrolling control device is also provided. The scrolling control device comprises a touchpad comprising a scrolling region, wherein a time span between two touches of an object on the two sections of the scrolling region corresponds to a displacement when at least two sections are touched successively. The displacement is in a specific direction determined by a location relationship between the touched sections.

In some embodiments of the present invention, the specific direction comprises a vertical direction. In some embodiments of the present invention, the specific direction comprises a horizontal direction. In some embodiments of the present invention, the specific direction comprises a vertical direction and a horizontal direction. In some embodiments of the present invention, the specific direction comprises a horizontal direction, a vertical direction, an upper right direction, a bottom right direction, an upper left direction, and a bottom left direction.

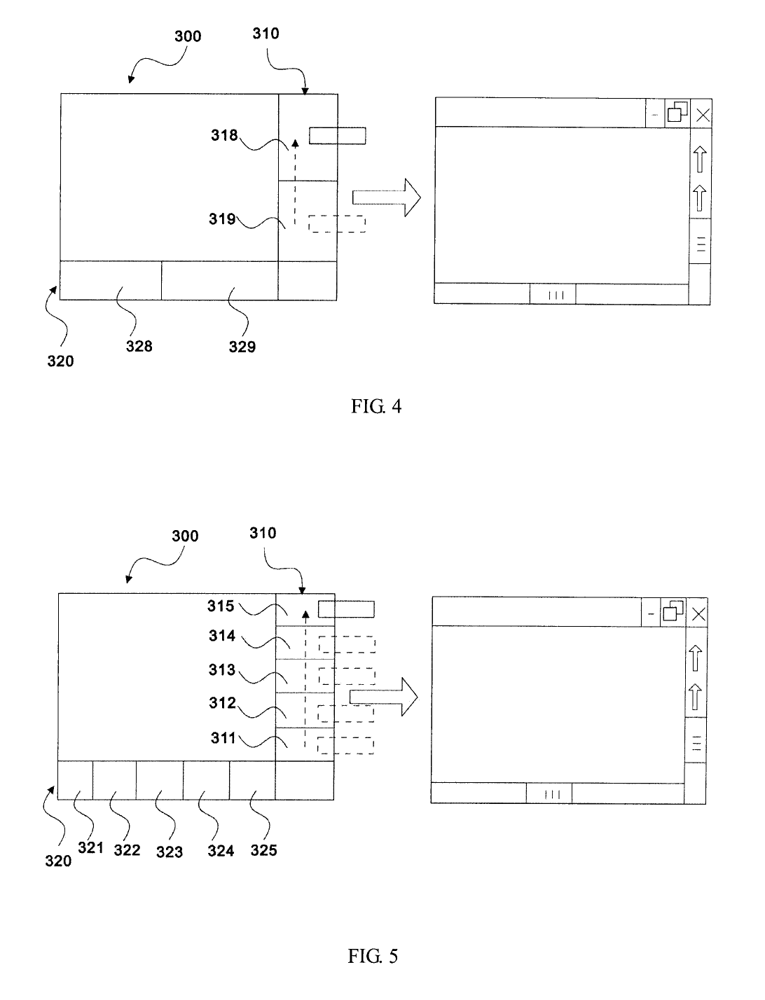

FIG. 4 is a schematic diagram of a scrolling operation on a touch device and the reaction of a window on a display device corresponding to the scrolling operation according to some embodiments of the present invention. As shown in FIG. 4, the touchpad 300 comprises a vertical scrolling region 310 and a horizontal scrolling region 320. The vertical scrolling region 310 is divided into two sections 318 and 319 and the horizontal scrolling region 320 is divided into two sections 328 and 329. When an object such as a finger touches on the section 318, and then leave the section 318 and touches on the section 319, the scrolling control method acts as follow: detecting a touch on the section 318; resetting a timer and starting timing; terminating timing if a touch of the object is detected on another section 319 and recording a time span T between the two touches; comparing the time span T with a first reference time and a second reference time; if the time span T is greater than a first reference time Tₘᵢₙ and less than a second reference time Tₘₐₓ, controlling a scroll bar to scroll a displacement in a specific direction on the window, wherein the displacement is V1 which is determined by the length of the time span T and the specific direction may be downward because the section 319 is below the section 318; if the time span T is not between the first reference time Tₘᵢₙ and the second reference time Tₘₐₓ, detecting a touch on a section again, and repeating the above steps; after the scroll bar is controlled to scroll a displacement, detecting whether the object is still on the touched section 319; if yes, controlling the scroll bar to scroll the same displacement in the same specific direction on the window, and then detecting whether the object is still on the touched section 319 again; if not, detecting a touch on a section again.

In some embodiments of the present invention, the greater the length of the time span T is, the larger the displacement of the scroll bar is. In some embodiments of the present invention, the less the length of the time span T is, the larger the displacement of the scroll bar is.

Referring FIG. 5, the touchpad 300 comprises a vertical scrolling region 310 and a horizontal scrolling region 320. The vertical scrolling region 310 is divided into five sections 311, 312, 313, 314 and 315, and the horizontal scrolling region 320 is divided into five sections 321, 322, 323, 324 and 325. When an object such as a finger touches on the section 311, 312, 313, 314 and 315 successively, the scrolling control method acts as follows:

detecting a touch on a section, for example, the section 311; resetting a timer and starting timing; terminating timing if a touch of the object is detected on another section, for example, the section 312 and recording a time span T; comparing the time span T with a first reference time and a second reference time; if the time span T is greater than a first reference time Tₘᵢₙ and less than a second reference time Tₘₐₓ, controlling a scroll bar to scroll a displacement in a specific direction on a window, wherein the displacement is V2 which is determined by the length of the time span T and the specific direction may be upward because the section 312 is above the section 311; if the time span is not between the first reference time Tₘᵢₙ and the second reference time Tₘₐₓ, detecting a touch on a section again; after the scroll bar is controlled to scroll a displacement, detecting whether the object is still on the touched section 312; if yes, controlling the scroll bar to scroll a same displacement in a same specific direction on the window, and then detecting whether the object is still on the touched section 312 again; if no, resetting a timer and starting timing;

when the object leaves the section 312, resetting a timer and starting timing; terminating timing if a touch of the object is detected on another section, for example, section 313, and recording a time span T; comparing the time span T with a first reference time and a second reference time; if the time span T is greater than a first reference time Tₘᵢₙ and less than a second reference time Tₘₐₓ, controlling a scroll bar to scroll a displacement in a specific direction on a window, wherein the displacement is V3 which is determined by the length of the time span T and the specific direction may be upward because the section 313 is above the section 312; if the time span T is not between the first reference time Tₘᵢₙ and the second reference time Tₘₐₓ, detecting a touch on a section again; after the scroll bar is controlled to scroll a displacement, detecting whether the object is still on the touched section 313; if yes, controlling the scroll bar to scroll a same displacement in a same specific direction on the window, and then detecting whether the object is still on the touched section 313 again; if not, resetting a timer and starting timing;

terminating timing if a touch of the object is detected on another section, for example, section 314, and recording a time span T; comparing the time span T with a first reference time and a second reference time, if the time span T is greater than a first reference time Tₘᵢₙ and less than a second reference time Tₘₐₓ, controlling a scroll bar to scroll a displacement in a specific direction on a window, wherein the displacement is V4 which is determined by the length of the time span T and the specific direction may be upward because the section 314 is above the section 313; if the time span T is not between the first reference time Tₘᵢₙ and the second reference time Tₘₐₓ, detecting a touch on a section again; after the scroll bar is controlled to scroll a displacement, detecting whether the object is still on the touched section 314; if yes, controlling the scroll bar to scroll a same displacement in a same specific direction on the window, and then detecting whether the object is still on the touched section 314 again; if not, resetting a timer and starting timing;

terminating timing if a touch of the object is detected on another section, for example, section 315, and recording a time span T; comparing the time span T with a first reference time and a second reference time; if the time span T is greater than a first reference time Tₘᵢₙ and less than a second reference time Tₘₐₓ, controlling a scroll bar to scroll a displacement in a specific direction on a window, wherein the displacement is V5 which is determined by the length of the time span T and the specific direction may be upward because the section 315 is above the section 314; if the time span T is not between the first reference time Tₘᵢₙ and the second reference time Tₘₐₓ, detecting a touch on a section again; after the scroll bar is controlled to scroll a displacement, detecting whether the object is still on the touched section 315; if yes, controlling the scroll bar to scroll a same displacement in a same specific direction on the window, and then detecting whether the object is still on the touched section 315 again; if not, resetting a timer and starting timing.

In some embodiments of the present invention, if the speed of the object is constant, that is to say that the time spans between every two touches are the same. The displacements are equal, and the scroll bar may scroll at a constant speed.

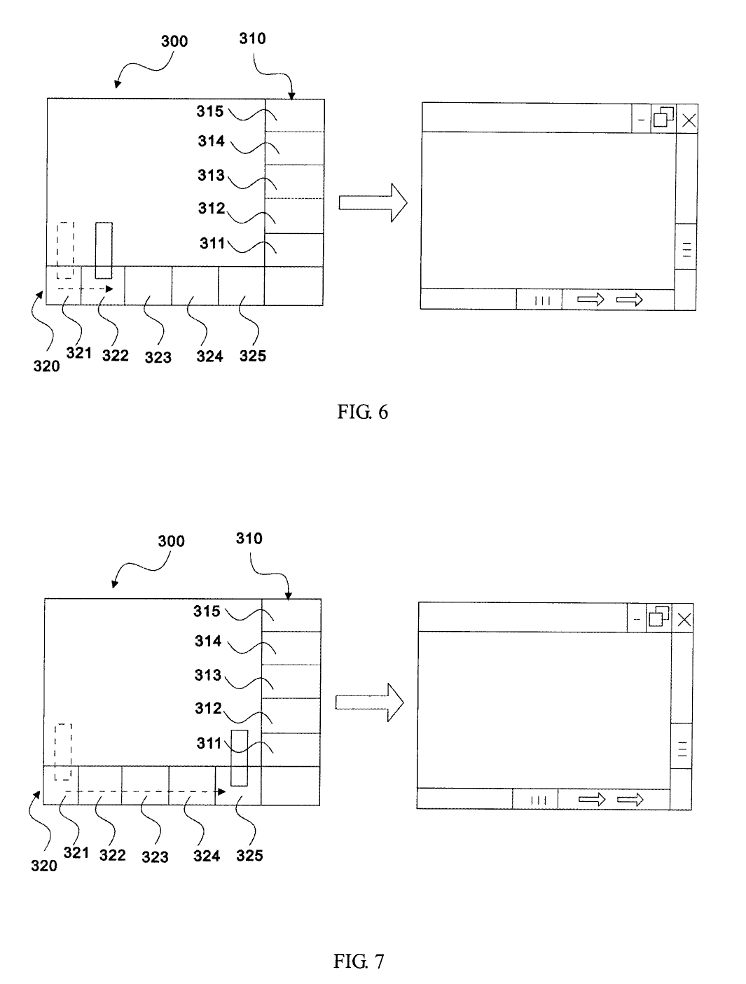

Referring FIG. 6, the touchpad 300 comprises a vertical scrolling region 310 and a horizontal scrolling region 320. The vertical scrolling region 310 is divided into five sections 311, 312, 313, 314 and 315, and the horizontal scrolling region 320 is divided into five sections 321, 322, 323, 324 and 325. When an object such as a finger touches on the section 321, and then leave the section 321 and touches on the section 322, the scrolling control method is as follows: detecting a touch on the section 321; resetting a timer and starting timing; terminating timing if a touch of the object is detected on another section 322 and recording a time span T; comparing the time span T with a first reference time and a second reference time; if the time span T is greater than a first reference time and less than a second reference time Tₘₐₓ, controlling a scroll bar to scroll a displacement in a specific direction on a window, wherein the displacement is V21 which is determined by the length of the time span T and the specific direction may be right because the section 322 is on the right side of the section 321; if the time span T is not between the first reference time and the second reference time Tₘₐₓ, detecting a touch on a section again; after the scroll bar is controlled to scroll a displacement, detecting whether the object is still on the touched section 322; if yes, controlling the scroll bar to scroll the same displacement in the same specific direction on the window, and then detecting whether the object is still on the touched section 322 again; if not, detecting a touch on a section again.

Referring FIG. 7, when an object such as a finger touches on the sections 321, 322, 323, 324 and 325 successively, the scrolling control method is similar to the method when an object such as a finger touches on the sections 311, 312, 313, 314 and 315 successively. It is unnecessary to describe it again in details.

In some embodiments of the present invention, if the speed of the object is constant, that is to say the time spans between every two sections are the same, so the displacements are equal, and the scroll bar may scroll at a constant speed.

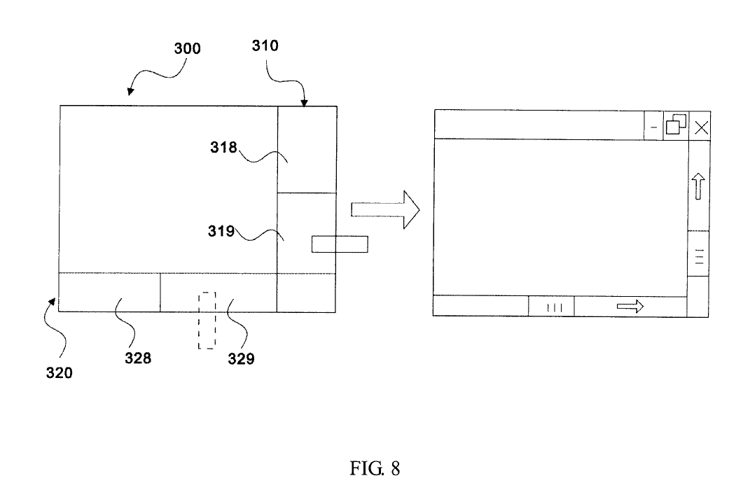

Referring FIG. 8, the touchpad 300 comprises a vertical scrolling region 310 and a horizontal scrolling region 320. The vertical scrolling region 310 is divided into two sections 318 and 319 and the horizontal scrolling region 320 is divided into two sections 328 and 329. When an object such as a finger touches on the section 329, and then leave the section 329 and touches on the section 319, the scrolling control method is as follows: detecting a touch on the section 329; resetting a timer and starting timing; terminating timing if a touch of the object is detected on another section 319 and recording a time span T; comparing the time span T with a first reference time and a second reference time; if the time span T is greater than a first reference time and less than a second reference time Tₘₐₓ, controlling a scroll bar to scroll a displacement in a specific direction on a window, wherein the displacement is V29 which is determined by the length of the time span T and the specific direction may be upper right because the section 319 is on the upper right side of the section 329; if the time span T is not between the first reference time Tₘᵢₙ and the second reference time Tₘₐₓ, detecting a touch on a section again; after the scroll bar is controlled to scroll a displacement, detecting whether the object is still on the touched section 319; if yes, controlling the scroll bar to scroll a same displacement in a same specific direction on the window, and then detecting whether the object is still on the touched section 319 again; if not, detecting a touch on a section again. In some embodiments of the present invention, the scroll direction is determined by the following steps: detecting the coordinates of the sections 319 and 329; determining the relative direction that the section 319 relates to the section 329; and determining the scrolling direction to be the same as the relative direction of the sections 319 and 329. When controlling the scroll bar to scroll, the method first controls the scroll bar to scroll rightwards and then scroll upwards.

According to the above mentioned embodiments, the specific direction may comprise a horizontal direction, a vertical direction, an upper right direction, a bottom right direction, an upper left direction, and a bottom left direction.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A scrolling control method for a touch device, comprising:
selecting a scrolling region on the touch device;
defining at least two sections on the scrolling region;
detecting touches of an object on at least two different sections successively, the time span between the touches of the object on the two sections corresponding to a displacement; and
controlling a scroll bar to scroll the displacement corresponding to the time span.

2. The method of claim 1, wherein at least two sections are disposed in a horizontal direction.

3. The method of claim 1, wherein at least two sections are disposed in a vertical direction.

4. The method of claim 1, wherein the displacement is in a specific direction, which is determined by the relative location of the at least two sections.

5. The method of claim 4, wherein the specific direction comprises a horizontal direction.

6. The method of claim 4, wherein the specific direction comprises a vertical direction.

7. The method of claim 4, wherein the specific direction is selected from a group consisting of a horizontal direction, a vertical direction, an upper right direction, a bottom right direction, an upper left direction, and a bottom left direction.

8. The method of claim 1 further comprising:
determining whether the time span between the touches on the two sections is greater than a first reference time and less than a second reference time;
if the time span is greater than the first reference time and less than the second reference time, performing the controlling step;
if the time span is not between the first reference time and the second reference time, detecting another touch of the object on the touch device.

9. A scrolling control device comprising a touchpad comprising a scrolling region, wherein a time span between touches of an object on two sections of the scrolling region corresponds to a scrolling displacement when the two sections are touched successively.

10. The device of claim 10, wherein the scrolling displacement is in a specific direction, which is determined by the relative location of the two sections.

11. The device of claim 10, wherein the specific direction comprises a horizontal direction.

12. The device of claim 10, wherein the specific direction comprises a vertical direction.
